(19) United States
(12) Patent Application Publication
(10) Pub. No.: US 2025/0079062 A1
(43) Pub. Date: Mar. 6, 2025

(54) Patterned Magnetic Flux Structure for Coupled Inductors

(71) Applicant: NVIDIA Corporation, Santa Clara, CA (US)

(72) Inventors: Youssef Elasser, Trenton, NJ (US); Sudhir Kudva, Dublin, CA (US); Mostafa Mosa, San Jose, CA (US)

(73) Assignee: NVIDIA Corporation, Santa Clara, CA (US)

(21) Appl. No.: 18/592,352

(22) Filed: Feb. 29, 2024

Related U.S. Application Data
(60) Provisional application No. 63/536,290, filed on Sep. 1, 2023.

(51) Int. Cl. H01F 27/24; H01F 27/28

(52) U.S. Cl. CPC H01F 27/24; H01F 27/28

(57) ABSTRACT

A magnetic inductor core forms a three-dimensional figure eight pattern. An upper member of the core forms an upper half of the figure eight pattern, a lower member of the core forms a lower half of the figure eight pattern, and central portions of the upper and lower members are separated from one another in a depth dimension by a main gap that passes transversely through the core from left to right sides of the figure eight pattern. The upper and lower members are joined at top and bottom sides of the figure eight pattern by core members that extend in the depth dimension between the upper and lower members. Coupled inductor components are be formed using the core such that magnetic flux associated with electrical current flowing in the inductor windings follows the figure eight pattern of the core in opposite directions, producing a flux cancelation effect inside the core.

### CROSS-REFERENCE TO RELATED APPLICATIONS

This application claims benefit to the filing date of U.S. Provisional Application 63/536,290, filed Sep. 1, 2023 (the “Provisional Application”), the contents of which are hereby incorporated by reference as if entirely set forth herein. In the event of a conflict between the meaning of terms used in the Provisional Application and the same or similar terms as used herein, the meanings associated with this application shall control.

### BACKGROUND

Voltage regulator modules (VRMs) are often used to deliver high output currents at low output voltages to microprocessors such as central processing units (CPUs) or graphics processing units (GPUs).

It is generally desirable to place a VRM in close proximity to its load. In so-called vertical power delivery (VPD) applications, for example, where power is delivered to a chip die through vias formed in a chip substrate, it is desirable to place VRMs on the chip substrate itself. In those and other applications, available space for placement of the VRMs can represent a significant constraint. In particular, for applications in which a VRM is to be placed on a substrate underneath a processor, available space in the vertical dimension becomes an important design constraint.

Meanwhile, a common design technique for VRMs is to place one or more inductors at the output of the VRM to regulate and filter the output voltage. Inductors used for this purpose must provide sufficient inductance over their desired region of operation, and their cores must be large enough not to saturate at the DC bias currents required by the application. Because core saturation is related to flux density, which in turn is related to cross sectional core area, it is the size of the output inductor(s) that typically dominates the overall size of VRM units.

Accordingly, it is desirable to limit the size of the output inductors used in a VRM unit while at the same time providing sufficient inductance levels to adequately regulate and filter the output voltage provided by the VRM unit. It is also desirable to limit the size of the output inductors in the vertical dimension.

### BRIEF DESCRIPTION OF THE DRAWINGS

FIG. 1 is an exploded view of a first example magnetic inductor core in accordance with embodiments.

FIG. 2 is a top view of the magnetic inductor core of FIG. 1 rotated approximately 90 degrees relative to the view of FIG. 1.

FIG. 3 is an assembled view of the magnetic inductor core of FIGS. 1 and 2 with two conductors disposed in the core to form a coupled inductor component in accordance with embodiments.

FIGS. 4A and 4B are exploded and rotated top views, respectively, of the magnetic inductor core of FIG. 3 showing a path of magnetic flux flowing through the core responsive to electric current flowing downward in a first one of the conductors of FIG. 3.

FIGS. 5A and 5B are exploded and rotated top views, respectively, of the magnetic inductor core of FIG. 3 showing a path of magnetic flux flowing through the core responsive to electric current flowing downward in a second one of the conductors of FIG. 3.

FIG. 6 is a computer simulation of the magnetic inductor core of FIG. 3 showing resultant flux density in the core responsive to electric current flowing in both conductors.

FIG. 7 is an exploded view of a second example magnetic inductor core in accordance with embodiments.

FIG. 8 is a top view of the magnetic inductor core of FIG. 7 rotated approximately 90 degrees relative to the view of FIG. 7.

FIG. 9A is an assembled view of the magnetic inductor core of FIG. 7 with two conductors disposed in the core to form a coupled inductor component in accordance with embodiments.

FIG. 9B is a side view illustrating an example profile of the conductors of FIG. 9A in accordance with embodiments.

FIGS. 10A and 10B are exploded and rotated top views, respectively, of the magnetic inductor core of FIG. 9A showing a path of magnetic flux flowing through the core responsive to electric current flowing downward in a first one of the conductors of FIG. 9A.

FIGS. 11A and 11B are exploded and rotated top views, respectively, of the magnetic inductor core of FIG. 9A showing a path of magnetic flux flowing through the core responsive to electric current flowing downward in a second one of the conductors of FIG. 9A.

FIG. 12 is a computer simulation of the magnetic inductor core of FIG. 9A showing resultant flux density in the core responsive to electric current flowing in both conductors.

FIG. 13 is an oblique view of an example magnetic inductor core in accordance with embodiments in which some or all of top and bottom members of the core are integrally formed with a lower core member and some or all of the top and bottom members are integrally formed with an upper core member.

FIG. 14 is an oblique view of an example magnetic inductor core in accordance with embodiments in which top and bottom members of the core are integrally formed with only one of the upper or the lower core members.

FIG. 15 is an oblique view of an example magnetic inductor core in accordance with embodiments in which all of the upper, lower, top, and bottom members of the core are discrete components.

FIG. 16 is a schematic diagram illustrating an example two-phase switching power supply circuit in which the coupled inductor components of FIG. 3 or FIG. 9 may be used in accordance with embodiments.

FIG. 17A is a side view of the coupled inductor components of FIG. 3 and FIG. 9.

FIG. 17B is a top view of the coupled inductor component of FIG. 9.

FIG. 17C is a top view of the coupled inductor component of FIG. 3.

FIG. 18 is a graph generally indicating electrical performance characteristics of embodiments as the width of elongate gaps in the upper and lower members of the core varies.

FIG. 19 is a graph generally indicating how inductance varies in embodiments as a function of DC bias current flowing in the conductors.

FIG. 20 is a graph generally indicating how steady state inductance varies in embodiments as the distance between the two conductors is varied.

FIG. 21 is a graph generally indicating how steady state inductance varies in embodiments as the height of the main gap in the inductor core is varied.

FIG. 22 is a side view of an integrated circuit chip substrate in which coupled inductor components of FIG. 3 or FIG. 9 are disposed inside and on exterior surfaces of the substrate in accordance with some embodiments.

### DETAILED DESCRIPTION

This disclosure describes multiple embodiments by way of example and illustration. It is intended that characteristics and features of all described embodiments may be combined in any manner consistent with the teachings, suggestions and objectives contained herein. Thus, phrases such as “in an embodiment,” “in one embodiment,” and the like, when used to describe embodiments in a particular context, are not intended to limit the described characteristics or features only to the embodiments appearing in that context.

The phrases “based on” or “based at least in part on” refer to one or more inputs that can be used directly or indirectly in making some determination or in performing some computation. Use of those phrases herein is not intended to foreclose using additional or other inputs in making the described determination or in performing the described computation. Rather, determinations or computations so described may be based either solely on the referenced inputs or on those inputs as well as others. The phrase “configured to” as used herein means that the referenced item, when operated, can perform the described function. In this sense an item can be “configured to” perform a function even when the item is not operating and is therefore not currently performing the function. Use of the phrase “configured to” herein does not necessarily mean that the described item has been modified in some way relative to a previous state. “Coupled” as used herein refers to a connection between items. Such a connection can be direct or can be indirect through connections with other intermediate items. Terms used herein such as “including,” “comprising,” and their variants, mean “including but not limited to.” Articles of speech such as “a,” “an,” and “the” as used herein are intended to serve as singular as well as plural references except where the context clearly indicates otherwise.

### First Example Embodiment

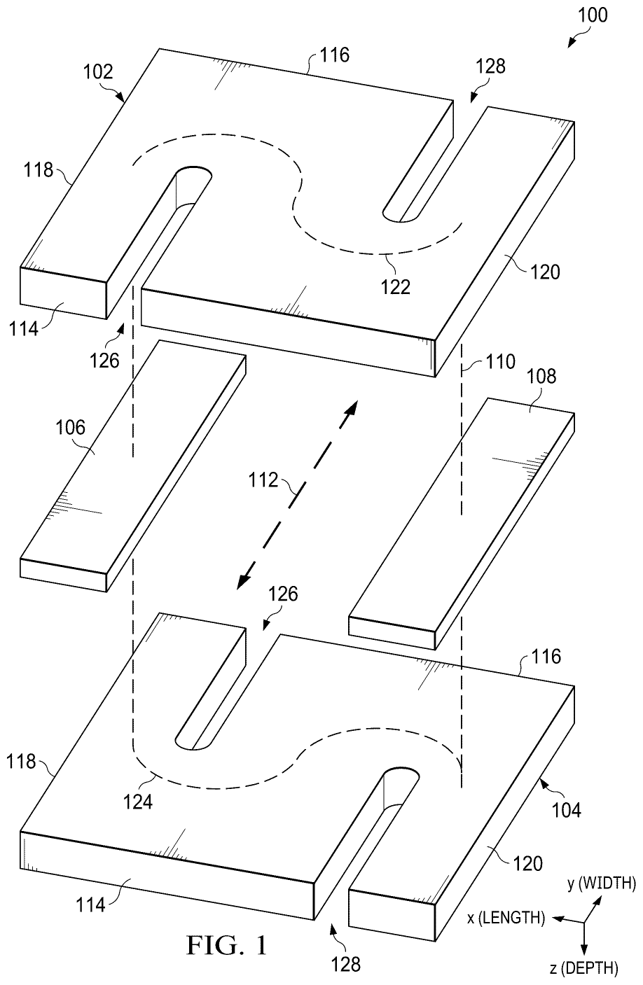

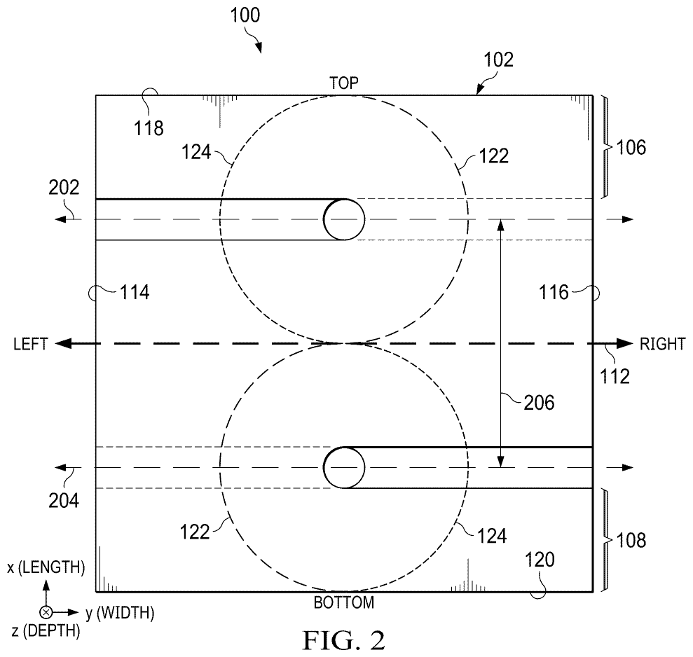

FIG. 1 is an exploded view illustrating a magnetic inductor core 100 that forms a three-dimensional figure eight pattern. FIG. 2 is a top view of the magnetic inductor core of FIG. 1 rotated approximately 90 degrees relative to view of FIG. 1. For ease of reference, mutually orthogonal x, y, z axes are drawn in each of FIGS. 1 and 2, with the z direction of FIG. 2 facing downward into the page. In each figure, the x dimension corresponds to length, the y dimension corresponds to width, and the z dimension corresponds to depth.

Inductor core 100 includes an upper member or volume 102, a lower member or volume 104, a top member or volume 106, and a bottom member or volume 108. Members 106 and 108 extend in the depth dimension 110 between the upper and lower members of the core as shown. Specifically, member 106 extends between the upper and lower members along a top side 118 of the core, effectively joining the upper and lower members at the top side of the core. Member 108 extends between the upper and lower members along a bottom side 120 of the core, effectively joining the upper and lower members at the bottom side of the core. Members 106 and 108 are separated from one another in the x dimension, and they separate the upper and lower members from one another in the z dimension, thus creating a main gap 112 that passes transversely through the core from a left side, 114, to a right side, 116, of the core.

When assembled, the core components collectively define a rectangular volume having a core length, a core width, and a core depth. The core length extends in the x dimension between the top side and the bottom side of the core. The core width extends in the y dimension from the left side to the right side of the core. The core depth extends in the z dimension from the upper-most surface of member 102 to the lower-most surface of member 104. The upper and lower members are disposed opposite one another in the z dimension and extend laterally across the core length and laterally across the core width.

The top-most surfaces of the upper and the lower members of the core, and of core member 106, comprise a top face of the core's rectangular volume. The bottom-most surfaces of the upper and the lower members of the core, and of core member 108, comprise a bottom face of the core's rectangular volume. The top and bottom faces of the rectangular volume are both orthogonal to the x axis. The left-most surfaces of the upper and the lower members of the core, and of core members 106, 108, comprise a left face of the core's rectangular volume. The right-most surfaces of the upper and the lower members of the core, and of core members 106, 108, comprise a right face of the core's rectangular volume. The left and right faces of the rectangular volume are both orthogonal to the y axis. The upper most-surface of upper member 102 comprises an upper face of the core's rectangular volume, and the lower-most surface of lower member 104 comprises a lower face of the core's rectangular volume. The upper and lower faces of the rectangular volume are both orthogonal to the z axis. Main gap 112 passes completely through the rectangular volume in the y direction.

The assembled core components form a three-dimensional figure eight pattern. In particular, the upper member of the core forms an upper half 122 of the figure eight pattern, while the lower member of the core forms a lower half 124 of the figure eight pattern. Core members 106, 108 join the two halves of the figure eight pattern in the depth dimension at the top side, 118, and at the bottom side, 120, of the figure eight, respectively.

To create the figure eight pattern, each of the upper and lower volumes includes two elongate gaps 126, 128 that extend partially across the core width from opposite sides. Specifically, the upper face of the core volume defines an upper left elongate gap (126) that extends partially into the upper face from the left, and an upper right elongate gap (128) that extends partially into the upper face from the right. The lower face of the core volume defines a lower right elongate gap (126) that extends partially into the lower face from the right, and a lower left elongate gap (128) that extends partially into the lower face from the left. Each elongate gap has a generally rectangular shape except that the profile of its termination in the interior of the core material may vary, as will be further explained below. In the embodiment shown, the elongate gaps are longer than they are wide and have a generally rectangular cross-sectional profile along their longitudinal dimension (in the dimension parallel with the y dimension of the device).

The elongate gaps create a generally S shaped profile in each of the upper and lower volumes of the core. The figure eight pattern is formed by arranging the top and the bottom volumes so that their respective S shaped profiles face in opposite directions, as shown, and by arranging the top core member (106) and the bottom core member (108) as described so that the two halves of the figure eight are joined at the top and at the bottom. Main gap 112 extends across the core width in the y direction between the top core member 106, the bottom core member 108, the upper core member 102, and the lower core member 104, such that central portions of each of the upper and lower core members are separated from one another in the depth dimension. At least a portion of each of the elongate gaps is disposed adjacent to the main gap so that the elongate gaps and the main gap form a continuous void in which the magnetic material of the core is absent.

As FIG. 2 illustrates, the upper left and lower right elongate gaps are centered on a first y-z plane 202, while the upper right and lower left elongate gaps are centered on a second y-z plane 204. The two y-z planes are separated from one another in the x direction. A distance 206 between the two y-z planes in the x direction will be referred to herein as the “x phase distance” or simply the “phase distance” or the “x phase.” Both of planes 202, 204 pass through main gap 112 such that, as was stated above, at least a portion of each elongate gap is continuous with the main gap such that a continuous void is formed comprising all of the elongate gaps and the main gap. In any embodiments, the void may be filled with air or another non-magnetic material such as a dielectric.

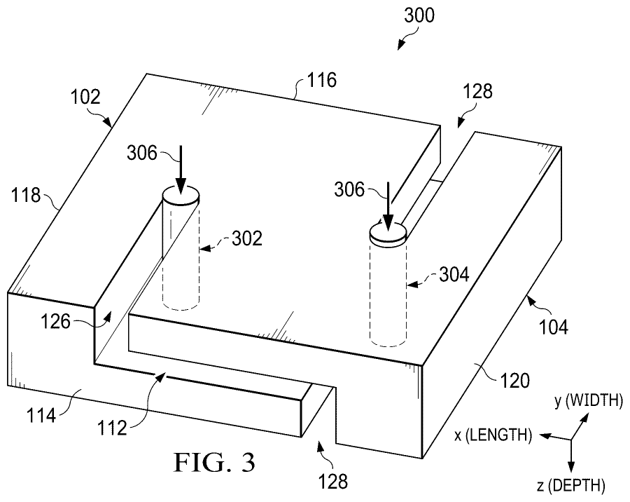

Referring now to the assembled view of FIG. 3, a coupled inductor component 300 may be formed by disposing first and second electrical conductors 302, 304 at least partially in the core as shown. When so disposed, the two conductors comprise coupled inductor windings of the coupled inductor component. Each conductor is partially disposed in the main gap and in one of the elongate gaps of each of the upper and lower core members.

The two conductors are configured to conduct electrical current in a manner such that magnetic flux associated with current in the respective conductors follows the figure eight pattern inside the core in opposite directions. This may be accomplished by causing the current to flow in direction 306 through each conductor. In the embodiment shown, for each conductor, electrical current flows in a path that enters the core through upper volume 102 and exits the core through lower volume 104. In other embodiments, the direction of arrows 306 may be reversed with the similar effect, provided that both arrows point in the same direction. In the latter embodiments, for each conductor, electrical current may flow in a path that enters the core through the bottom volume and exits the core through the top volume.

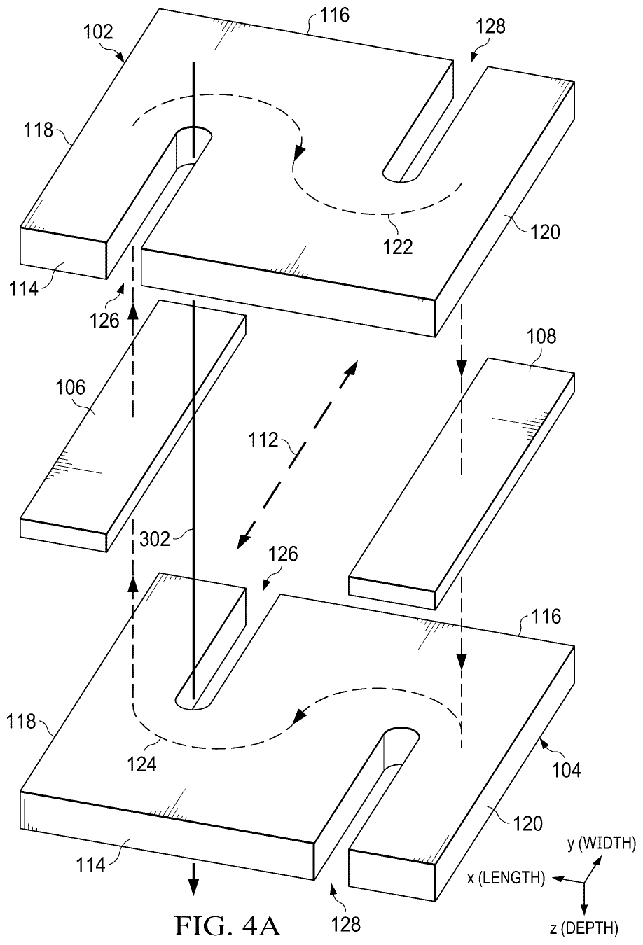

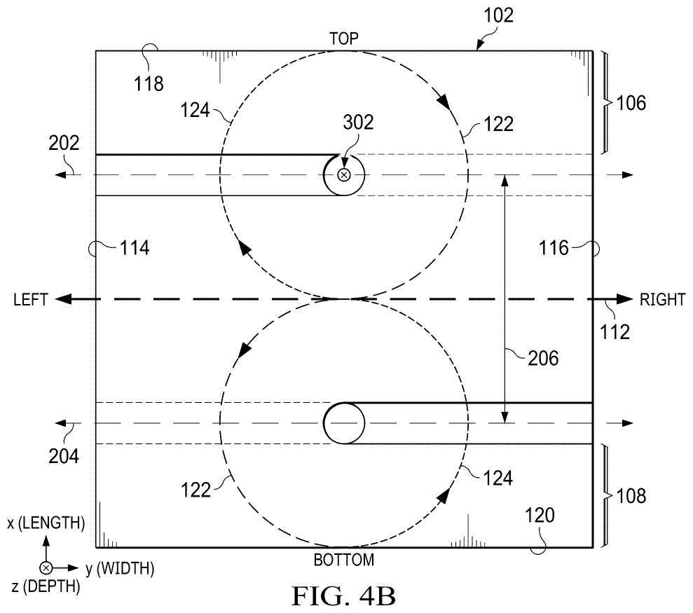

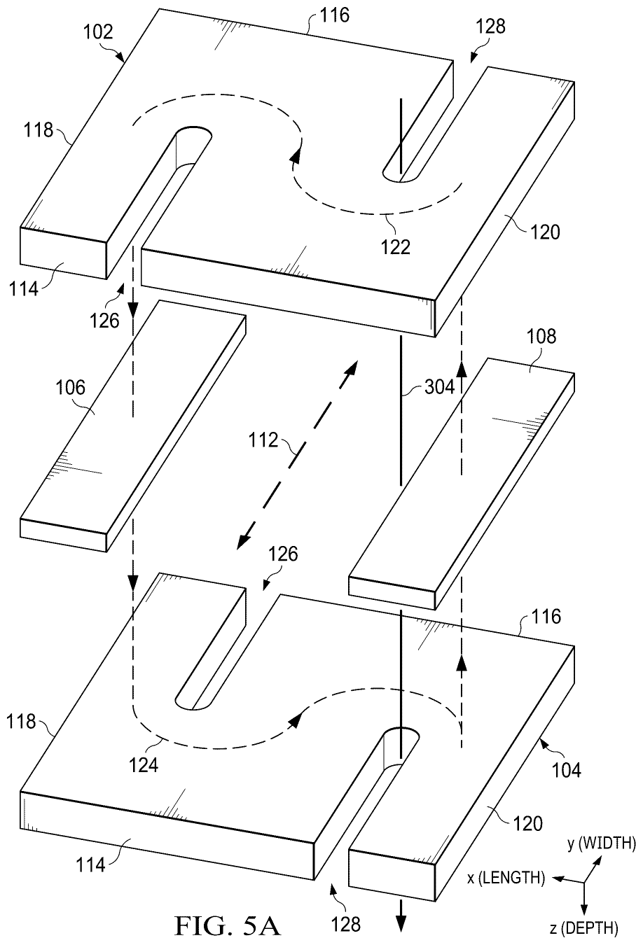

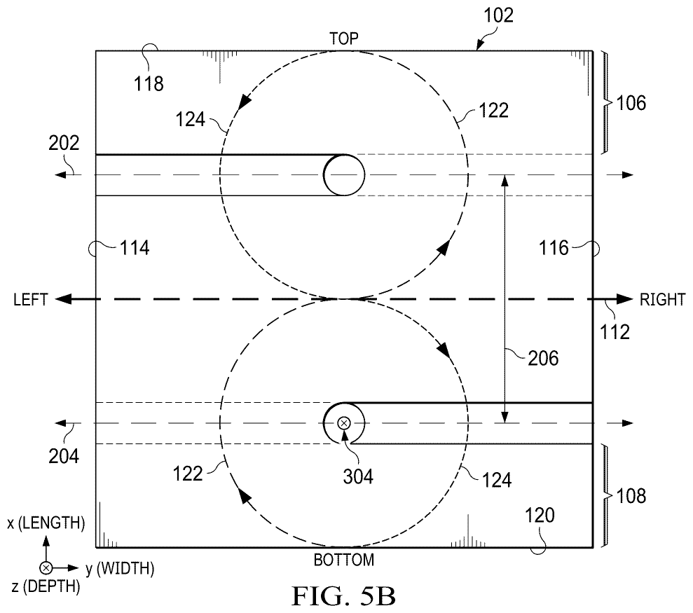

FIGS. 4A, 4B, 5A, and 5B illustrate the magnetic flux paths that result from current flow in the coupled inductor windings. FIGS. 4A and 4B illustrate the path of magnetic flux associated with current flowing in a downward direction through conductor 302, while FIGS. 5A and 5B illustrate the path of magnetic flux associated with current flowing in a downward direction through conductor 304. In both of FIGS. 4B and 5B, an X indicates current flowing into a conductor in the z direction (into the page).

Referring now to FIGS. 4A and 4B, the path of magnetic flux associated with conductor 302 is shown at 122 in the upper core member and at 124 in the lower core member. As the figure illustrates, the magnetic flux follows a clockwise path around the conductor in the top half 118 of the upper core member and follows a counterclockwise path in the bottom half 120 of the upper core member. The path then travels downward through core member 108 into the lower core member. In the lower core member, the path follows a counterclockwise path around the bottom half 120 of the lower core member and follows a clockwise path around the conductor in the top half 118 of the lower core member. The path is completed by traveling upward again through core member 106 to the upper core member.

Referring now to FIGS. 5A and 5B, the path of magnetic flux associated with conductor 304 is shown at 122 in the upper core member and at 124 in the lower core member. As the figure illustrates, the magnetic flux path follows a clockwise path around the conductor in the bottom half 120 of the upper core member and follows a counterclockwise path in the top half 118 of the upper core member. The path then travels downward through core member 106 into the lower core member. In the lower core member, the path follows a counterclockwise path around the top half 118 of the lower core member and follows a clockwise path around the conductor in the bottom half 120 of the lower core member. The path is completed by traveling upward again through core member 108 to the upper core member.

As FIGS. 4 and 5 illustrate, the magnetic flux associated with inductor winding 304 follows the same path through the core as does the magnetic flux associated with inductor winding 302, but in the opposite direction. By inversely coupling the magnetic flux associated with the two inductors in this manner, the DC flux induced by one winding at least partially cancels the DC flux induced by the other winding. The result of the flux cancelation is a reduction in DC flux density throughout the magnetic core, which in turn enables much higher DC bias currents to be used in the device without saturating the magnetic core.

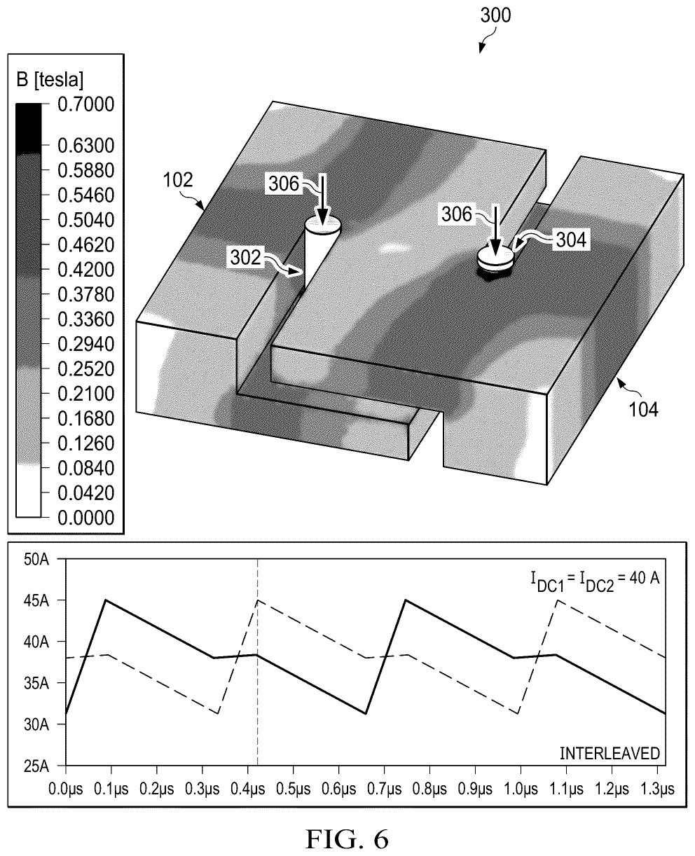

The computer-generated model of FIG. 6 illustrates this flux cancelation effect inside inductor component 300 in the context of a two-phase switching power supply system according to FIG. 16 (to be further described below) in which DC currents in the two inductor windings ramp repeatedly in an interleaved fashion, as illustrated at the bottom of the drawing, each with a DC bias current of 40 amperes. FIG. 6 shows current waveforms and flux density simulations for the coupled inductor component at a switching frequency of 1.5 MHz, with input voltage Vᵢₙ=6 V, and with output voltage Vₒᵤₜ=0.8 V.

Magnetic flux density throughout the magnetic core is indicated with shading according to the scale shown at the left of the drawing. As the shading illustrates, while flux density is high immediately around the circular cross section of each conductor, flux density is reduced in the other areas of the core volume. In particular, flux density is near zero in the center of each of the upper and lower core members and at the corners of the core volume.

As used herein, D refers to the duty cycle of a switching signal, and T refers to the switching period of the signal (i.e., T corresponds to the inverse of the switching frequency of the signal). Thus, D corresponds to a percentage of time in which a switching signal is in an “on” state relative the switching period, T, of the signal.

During interleaved operation, the current through each of the two inductor windings at time t=D×T or t=T/2+D×T during a switching cycle is at its maximum difference. In conventional devices, this mismatch can cause the inductor core to enter saturation earlier than if the currents in the two phases were equally matched. As can be seen from the shaded model, however, a magnetic core structure according to embodiments shows robustness against current mismatch. For example, the flux density distribution shown in the model is taken at the point indicated by the dashed line in the current waveform, when t=T/2+D×T. As the drawing illustrates, the coupling coefficient is not too high, yet still achieves enough DC flux cancellation to operate at up to 40 A per phase without saturating the core. The steady-state inductance of each phase at 40 A is 33 nH, and the leakage inductance is 27 nH.

### Second Example Embodiment

Note that, in the embodiments of FIGS. 1-6, the elongate gaps are sufficiently long that end portions of the elongate gaps in the upper volume of the core overlap with end portions of the elongate gaps in the lower volume of the core so that first and second through holes 208, 210 are established. Each of the through holes passes completely through the magnetic core material in the z direction. In these embodiments, a z-oriented longitudinal element of each conductor is disposed in a respective one of the through holes.

The z-oriented longitudinal elements of each conductor may have a diameter d, and each of the elongate gaps may have a length substantially equal to w/2+d/2, where w corresponds to the width (in the y direction) of the magnetic core.

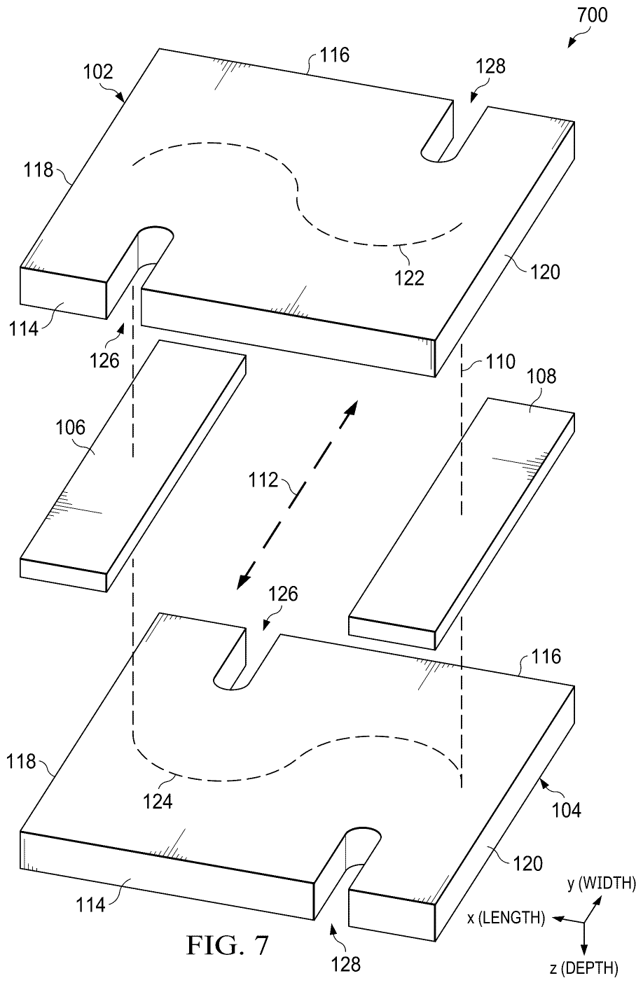

In other embodiments, each of the elongate gaps may have a length less than or equal to w/2. The latter embodiments will now be described with reference to FIGS. 7-12.

The example embodiment shown in FIGS. 7-12 is similar to the example embodiment of FIGS. 1-6 except that the elongate gaps in the embodiments of FIGS. 7-12 are shorter than those in the embodiment of FIGS. 1-6 such that through holes 208, 210 are not present in the embodiment of FIGS. 7-12. All of the other elements of the embodiment of FIGS. 7-12, however, are analogous to those in the embodiment of FIGS. 1-6. Therefore, reference numbers from FIGS. 1-6 are applied to analogous elements of FIGS. 7-12, and all of the descriptions given above with respect to so-numbered elements in FIGS. 1-6 are applicable to the correspondingly numbered elements in FIGS. 7-12, as follows. As was the case in the embodiments of FIGS. 1-6, each elongate gap in the embodiments of FIGS. 7-12 has a generally rectangular shape except that the profile of its termination in the interior of the core material may vary, as will be further explained below. In the embodiment shown, the elongate gaps are longer than they are wide and have a generally rectangular cross-sectional profile along their longitudinal dimension (in the dimension parallel with the y dimension of the device).

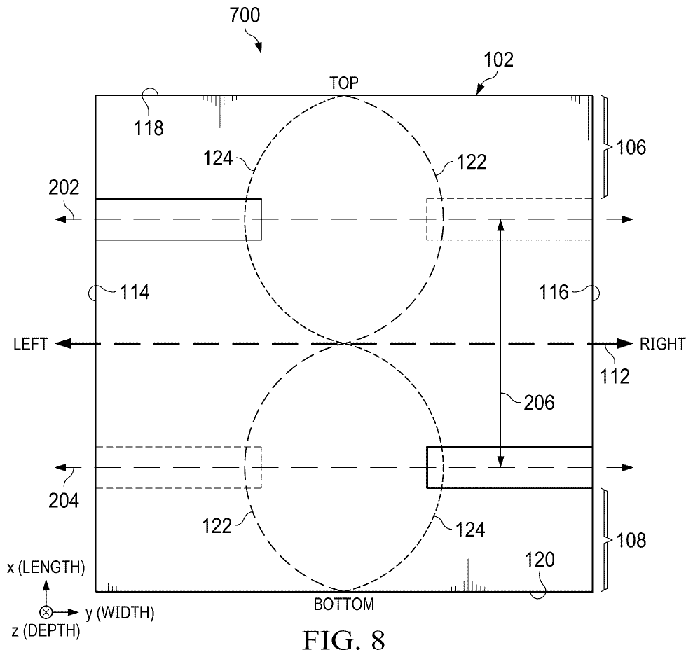

FIG. 7 is an exploded view illustrating a magnetic inductor core 700 that, like inductor core 100, forms a three-dimensional figure eight pattern. FIG. 8 is a top view of the magnetic inductor core of FIG. 7 rotated approximately 90 degrees relative to view of FIG. 7. For ease of reference, mutually orthogonal x, y, z axes are drawn in each of FIGS. 7 and 8, with the z direction of FIG. 8 facing downward into the page. In each figure, the x dimension corresponds to length, the y dimension corresponds to width, and the z dimension corresponds to depth.

Inductor core 700 includes an upper member or volume 102, a lower member or volume 104, a top member or volume 106, and a bottom member or volume 108. Members 106 and 108 extend in the depth dimension 110 between the upper and lower members of the core as shown. Specifically, member 106 extends between the upper and lower members along a top side 118 of the core, effectively joining the upper and lower members at the top side of the core. Member 108 extends between the upper and lower members along a bottom side 120 of the core, effectively joining the upper and lower members at the bottom side of the core. Members 106 and 108 are separated from one another in the x dimension, and they separate the upper and lower members from one another in the z dimension, thus creating a main gap 112 that passes transversely through the core from a left side, 114, to a right side, 116, of the core.

When assembled, the core components collectively define a rectangular volume having a core length, a core width, and a core depth. The core length extends in the x dimension between the top side and the bottom side of the core. The core width extends in the y dimension from the left side to the right side of the core. The core depth extends in the z dimension from the upper-most surface of member 102 to the lower-most surface of member 104. The upper and lower members are disposed opposite one another in the z dimension and extend laterally across the core length and laterally across the core width.

The top-most surfaces of the upper and the lower members of the core, and of core member 106, comprise a top face of the core's rectangular volume. The bottom-most surfaces of the upper and the lower members of the core, and of core member 108, comprise a bottom face of the core's rectangular volume. The top and bottom faces of the rectangular volume are both orthogonal to the x axis. The left-most surfaces of the upper and the lower members of the core, and of core members 106, 108, comprise a left face of the core's rectangular volume. The right-most surfaces of the upper and the lower members of the core, and of core members 106, 108, comprise a right face of the core's rectangular volume. The left and right faces of the rectangular volume are both orthogonal to the y axis. The upper most-surface of upper member 102 comprises an upper face of the core's rectangular volume, and the lower-most surface of lower member 104 comprises a lower face of the core's rectangular volume. The upper and lower faces of the rectangular volume are both orthogonal to the z axis. Main gap 112 passes completely through the rectangular volume in the y direction.

The assembled core components form a three-dimensional figure eight pattern. In particular, the upper member of the core forms an upper half 122 of the figure eight pattern, while the lower member of the core forms a lower half 124 of the figure eight pattern. Core members 106, 108 join the two halves of the figure eight pattern in the depth dimension at the top side, 118, and at the bottom side, 120, of the figure eight, respectively.

To create the figure eight pattern, each of the upper and lower volumes includes two elongate gaps 126, 128 that extend partially across the core width from opposite sides. Specifically, the upper face of the core volume defines an upper left elongate gap (126) that extends partially into the upper face from the left, and an upper right elongate gap (128) that extends partially into the upper face from the right. The lower face of the core volume defines a lower right elongate gap (126) that extends partially into the lower face from the right, and a lower left elongate gap (128) that extends partially into the lower face from the left.

The elongate gaps create a generally S shaped profile in each of the upper and lower volumes of the core. The figure eight pattern is formed by arranging the top and the bottom volumes so that their respective S shaped profiles face in opposite directions, as shown, and by arranging the top core member (106) and the bottom core member (108) as described so that the two halves of the figure eight are joined at the top and at the bottom. Main gap 112 extends across the core width in the y direction between the top core member 106, the bottom core member 108, the upper core member 102, and the lower core member 104, such that central portions of each of the upper and lower core members are separated from one another in the depth dimension. At least a portion of each of the elongate gaps is disposed adjacent to the main gap so that the elongate gaps and the main gap form a continuous void in which the magnetic material of the core is absent.

As FIG. 8 illustrates, the upper left and lower right elongate gaps are centered on a first y-z plane 202, while the upper right and lower left elongate gaps are centered on a second y-z plane 204. The two y-z planes are separated from one another in the x direction. A distance 206 between the two y-z planes in the x direction will be referred to herein as the “x phase distance” or simply the “phase distance” or the “x phase.” Both of planes 202, 204 pass through main gap 112 such that, as was stated above, at least a portion of each elongate gap is continuous with the main gap such that a continuous void is formed comprising all of the elongate gaps and the main gap. In any embodiments, the void may be filled with air or another non-magnetic material such as a dielectric.

Note that, in some of the figures, the elongate gaps are shown as having rounded ends, whereas in other figures the elongate gaps are shown as having squared ends. Specifically, FIGS. 8, 9, 10B, 11B, 17A, and 17B depict squared ends, and FIGS. 1-7, 10A, 11A, 12-15, and 17C depict squared ends. This is simply to illustrate that the elongate gaps may be constructed with a variety of profiles at the termination of the gap in the interior of the core material. For example, the elongate gaps in any embodiments, including those in the embodiments shown in FIGS. 1-6, may be constructed such that their interior ends have a rounded profile, a squared profile, or another profile that is neither rounded nor square.

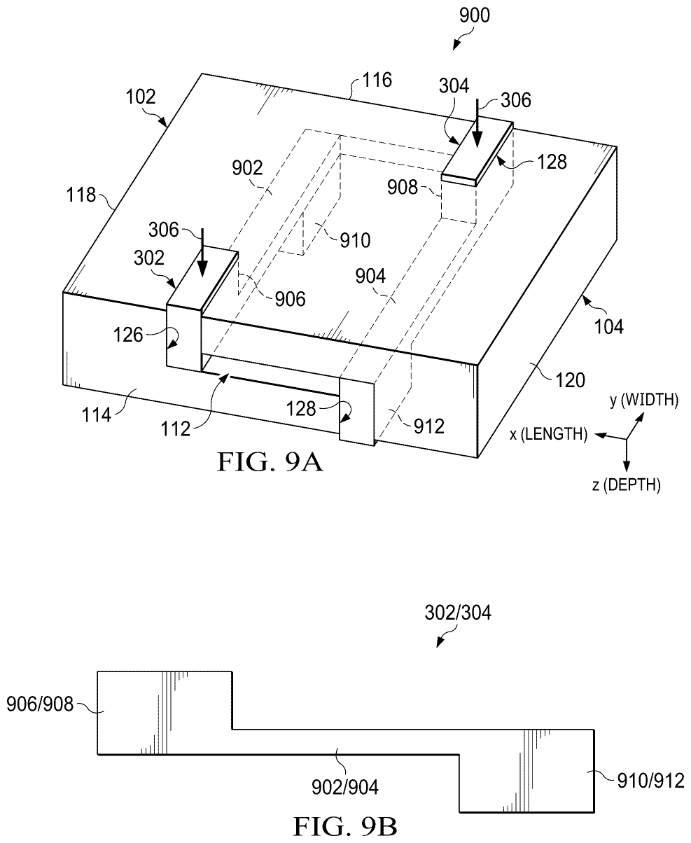

FIG. 9A is an oblique assembled view illustrating an example coupled inductor component formed using magnetic inductor core 700. FIG. 9B provides a side view of one of the two inductor windings of FIG. 9B. (The two inductor windings may be identical.)

Referring now to the assembled view of FIG. 9A, a coupled inductor component 900 may be formed by disposing first and second electrical conductors 302, 304 at least partially in the core as shown. When so disposed, the two conductors comprise coupled inductor windings of the coupled inductor component. Each conductor is partially disposed in the main gap and in one of the elongate gaps of each of the upper and the lower core members.

The two conductors are configured to conduct electrical current in a manner such that magnetic flux associated with current in the respective conductors follows the figure eight pattern inside the core in opposite directions. This may be accomplished by causing the current to flow in direction 306 through each conductor. In the embodiment shown, for each conductor, electrical current flows in a path that enters the core through upper volume 102 and exits the core through lower volume 104. In other embodiments, the direction of arrows 306 may be reversed with the similar effect, provided that both arrows point in the same direction. In the latter embodiments, for each conductor, electrical current may flow in a path that enters the core through the bottom volume and exits the core through the top volume.

As FIG. 9B illustrates, a difference between embodiment 900 and embodiment 300 is that the two conductors of embodiment 900 each include a transverse conducting element 902, 904 that is disposed inside main gap 112 and has a longitudinal axis oriented in the y direction, as shown. Each of conductors 302, 304 in embodiment 900 includes an upper conducting element 906, 908 (a contact conductor) that is at least partially exposed in one of the elongate gaps of the upper volume 102, and includes a lower conducting element 910, 912 (a contact conductor) that is at least partially exposed in one of the elongate gaps of the lower volume 104. Embodiment 300 may also include such transverse contact conductors, if desired.

Despite the differences in structure between the conductors of embodiment 900 and the conductors of embodiment 300, it remains the case that the conductors of embodiment 900 are configured to conduct electrical current along a path that enters the device through the upper volume and exits the device through the lower volume. In such embodiments, the electrical current in transverse element 902 flows in the y direction, while the electrical current in transverse element 904 flows through in the negative y direction. As was explained above, however, in other embodiments the paths may be reversed such that electrical current flowing in both conductors follows a path that enters the device through the lower volume and exits the device through the upper volume. In the latter embodiments, the electrical current in transverse element 902 would flow in the negative y direction, while the electrical current in transverse element 904 would flow in the y direction.

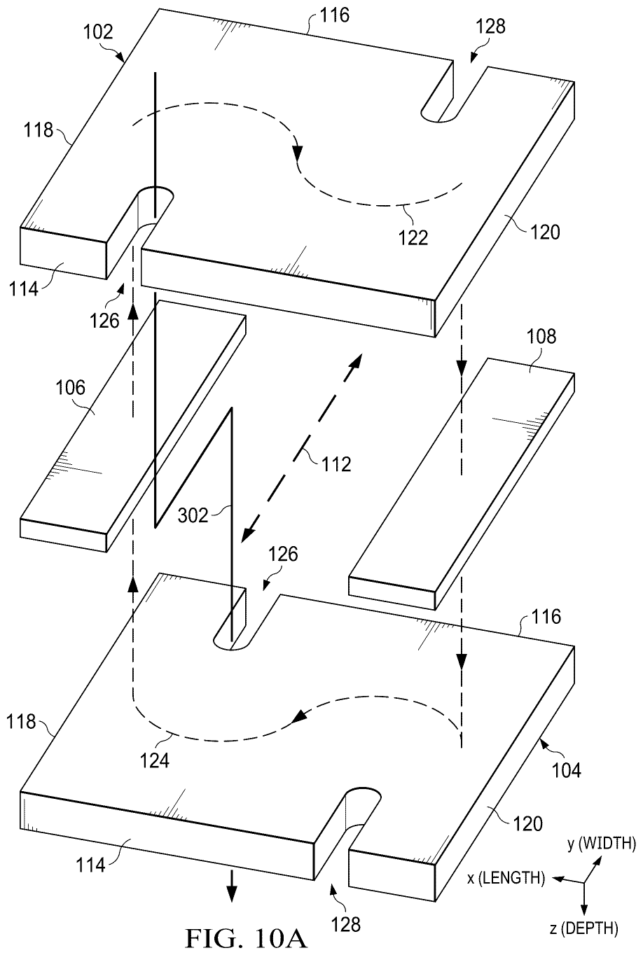

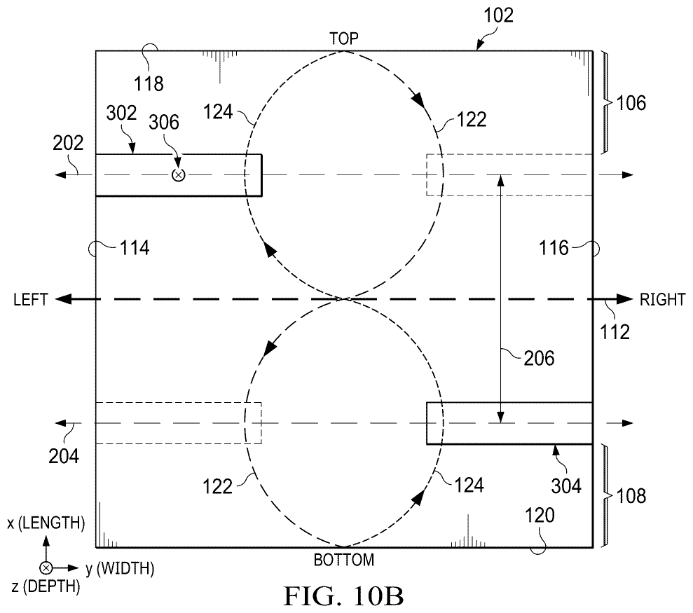

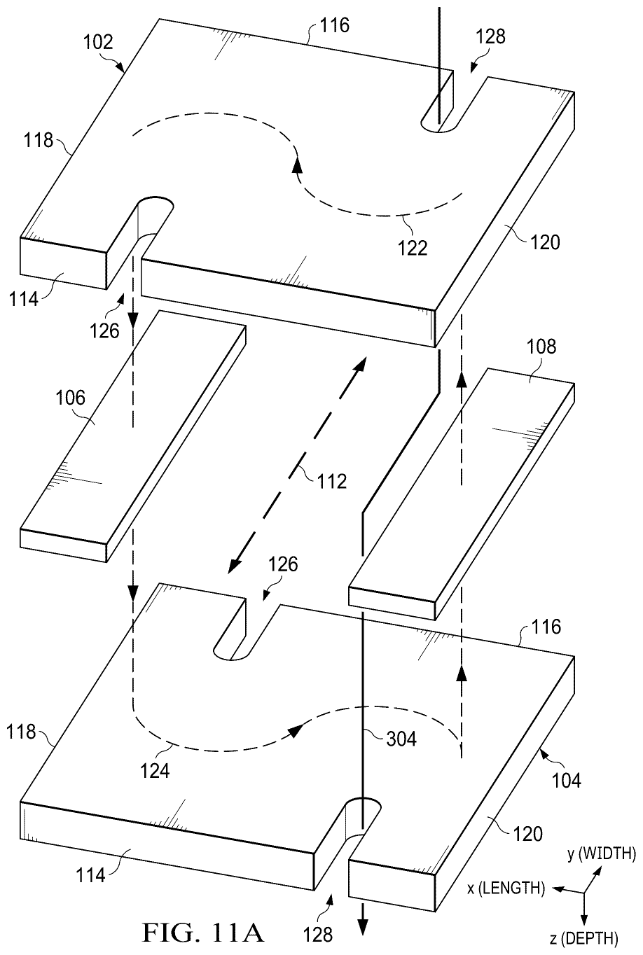

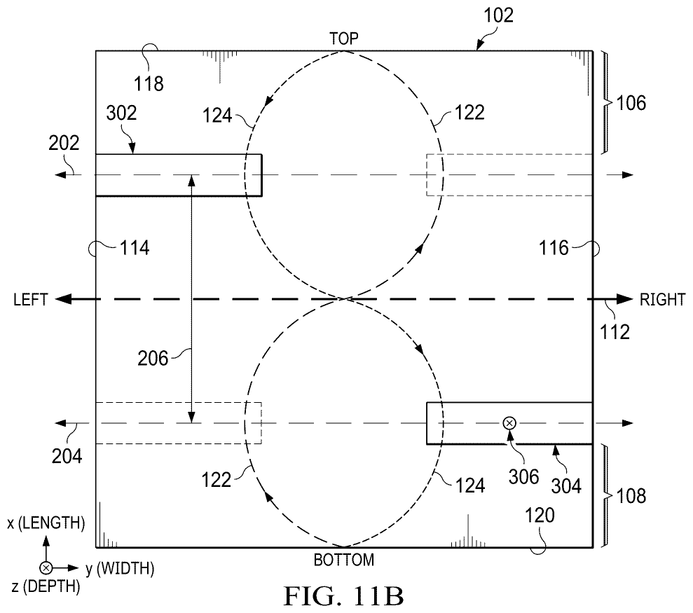

FIGS. 10A, 10B, 11A, and 11B illustrate the magnetic flux paths that result from current flow in the coupled inductor windings of inductor component 900. FIGS. 10A and 10B illustrate the path of magnetic flux associated with current flowing in a downward direction through conductor 302, while FIGS. 11A and 11B illustrate the path of magnetic flux associated with current flowing in a downward direction through conductor 304. In both of FIGS. 10B and 11B, an X indicates current flowing into a conductor in the z direction (into the page).

Referring now to FIGS. 10A and 10B, the path of magnetic flux associated with conductor 302 is shown at 122 in the upper core member and at 124 in the lower core member. As the figure illustrates, the magnetic flux path follows a clockwise path around the conductor in the top half 118 of the upper core member and follows a counterclockwise path in the bottom half 120 of the upper core member. The path then travels downward through core member 108 into the lower core member. In the lower core member, the path follows a counterclockwise path around the bottom half 120 of the lower core member and follows a clockwise path around the conductor in the top half 118 of the lower core member. The path is completed by traveling upward again through core member 106 to the upper core member.

Referring now to FIGS. 11A and 11B, the path of magnetic flux associated with conductor 304 is shown at 122 in the upper core member and at 124 in the lower core member. As the figure illustrates, the magnetic flux path follows a clockwise path around the conductor in the bottom half 120 of the upper core member and follows a counterclockwise path in the top half 118 of the upper core member. The path then travels downward through core member 106 into the lower core member. In the lower core member, the path follows a counterclockwise path around the top half 118 of the lower core member and follows a clockwise path around the conductor in the bottom half 120 of the lower core member. The path is completed by traveling upward again through core member 108 to the upper core member.

A difference between the magnetic flux patterns for inductor component 900 and inductor component 300 is that the figure eight pattern followed by magnetic flux in component 900 is slightly more narrow in the left to right dimension (the y dimension) than is the figure eight pattern followed by magnetic flux in component 300. This can be seen by comparing FIGS. 10B, 11B with FIGS. 5A, 5B.

As FIGS. 10 and 11 illustrate, the magnetic flux associated with inductor winding 304 of inductor component 900 follows the same path through the core as does the magnetic flux associated with inductor winding 302, but in the opposite direction. As was the case with inductor component 300, by inversely coupling the magnetic flux associated with the two inductors inside the core of inductor component 900 in this manner, the DC flux induced by one winding at least partially cancels the DC flux induced by the other winding. The result of the flux cancelation is a reduction in DC flux density throughout the magnetic core, which in turn enables much higher DC bias currents to be used in the device without saturating the magnetic core.

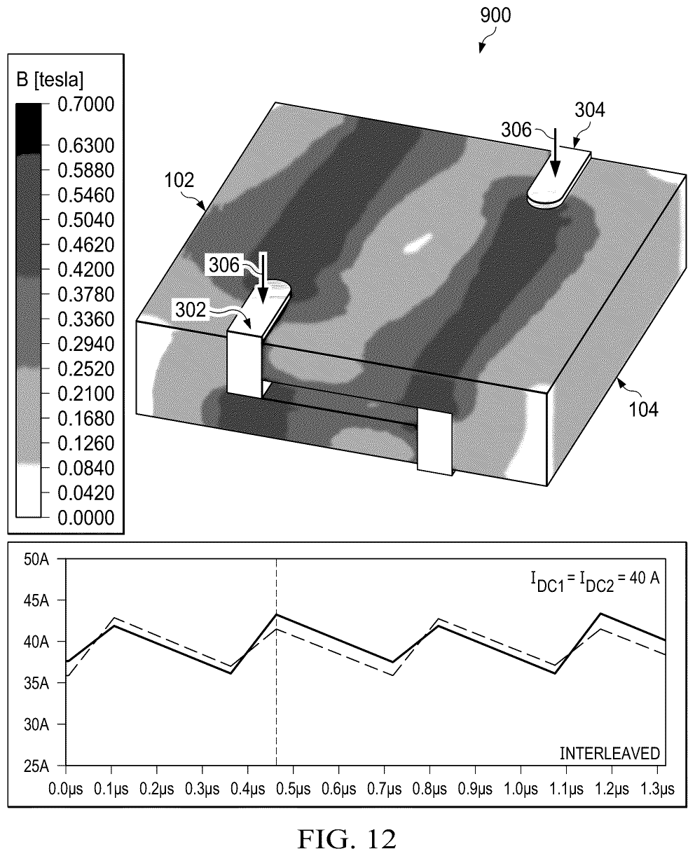

The computer-generated model of FIG. 12 illustrates this flux cancelation effect inside inductor component 900 for a system in which DC currents in the two conductors ramp repeatedly in an interleaved fashion, as illustrated at the bottom of the drawing, each with a DC bias current of 40 amperes. Magnetic flux density throughout the magnetic core is indicated with shading according to the scale shown at the left of the drawing. As the shading illustrates, and as was the case with inductor component 300, flux density is reduced in most areas of the core volume. In particular, flux density is near zero in the center of each of the upper and lower core members and at the corners of the core volume.

### Conductors in Embodiments

In all embodiments, conductor 302 is disposed in at least part of the upper left elongate gap and in at least part of the lower right elongate gap. Similarly, conductor 304 is disposed in at least part of the upper right elongate gap and in at least part of the lower left elongate gap.

In embodiments that include transverse conductive elements, the transverse conductive elements may be disposed along the top and bottom sides of main gap 112, respectively. One of the transverse conductive elements may be exposed at the upper face of the core by the upper left elongate gap and may be exposed at the lower face of the core by the lower right elongate gap. Similarly, the other of the two transverse conductive elements may be exposed at the upper face of the core by the upper right elongate gap, and may be exposed at the lower face of the core by the lower left elongate gap. Each transverse conductive element may pass through the main gap in the transverse (y) direction. As was mentioned above, for each transverse conductor, a portion of the conductor may extend through the elongate gap in the depth dimension, thus exposing a contact conductor at the upper or the lower face of the core. The respective contact conductors may be used to couple the inductor device to other circuitry.

### Materials

Magnetic cores according to embodiments may be constructed using any of a variety of magnetic materials. For example, in some embodiments, a manganese-zinc ferrite material may be used such as any of the ML91S or ML95S Mn—Zn soft ferrite core materials available from Hitachi Metals, Ltd. In other embodiments, a nickel-zinc ferrite material may be used. Various other ferrite materials may also be used in embodiments in accordance with requirements of the host systems in which the respective inductor components will be deployed.

Electrical conductors used in embodiments may comprise any electrically conductive material. For example, the electrical conductors may comprise copper.

### Manufacture

Magnetic cores according to embodiments may be manufactured in a variety of ways, several examples of which will now be described.

In some embodiments, the entirety of a core 100 or a core 700, including all of the core components 102, 104, 106, 108, may be constructed from a unitary piece of magnetic material. In such embodiments, the main gap and the elongate gaps may be formed inside a solid volume of magnetic core material using known tooling techniques such as drilling. In such a case, the finished core comprises a unitary piece of magnetic material.

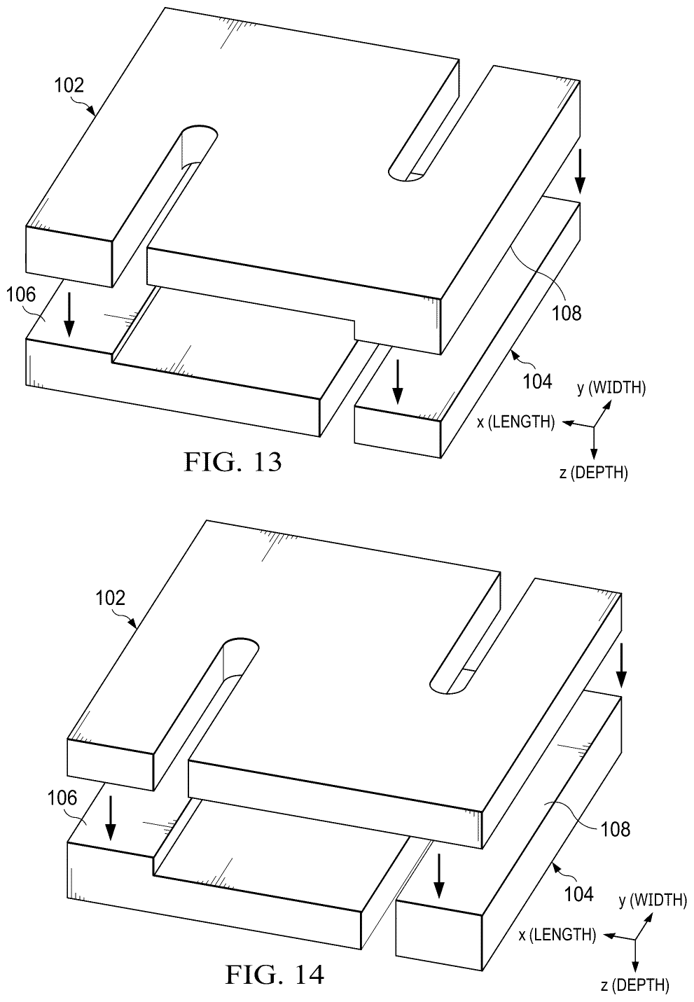

In other embodiments, the core may comprise two or more pieces of magnetic material that are assembled together to form a completed unit. FIGS. 13-15 illustrate three such embodiments by way of example.

FIG. 13 illustrates a class of embodiments in which upper volume 102 and lower volume 104 are discrete elements, each of which is a unitary piece, and in which some or all of top volume 106 and some or all of bottom volume 108 are integrally formed with the upper volume or with the lower volume. For example, the upper and lower volumes may be identical, each having the entire depth of a top/bottom member formed on one end thereof, or having 50% of the depth of a top/bottom member formed on each end thereof. In either case, a completed core may be formed by rotating one of the two identical members 180 degrees relative to the other and joining them as shown in the drawing, such that the completed top volume is disposed as illustrated at 106 and the completed bottom volume is disposed as illustrated at 108.

FIG. 14 illustrates a class of embodiments in which upper volume 102 and lower volume 104 are discrete elements, each of which is a unitary piece, and in which both of top volume 106 and bottom volume 108 are integrally formed with just one of the upper volume or the lower volume. In the illustrated example, the top and bottom volumes 106, 108 are integrally formed with lower volume 104. In other embodiments, they may be integrally formed with upper volume 102.

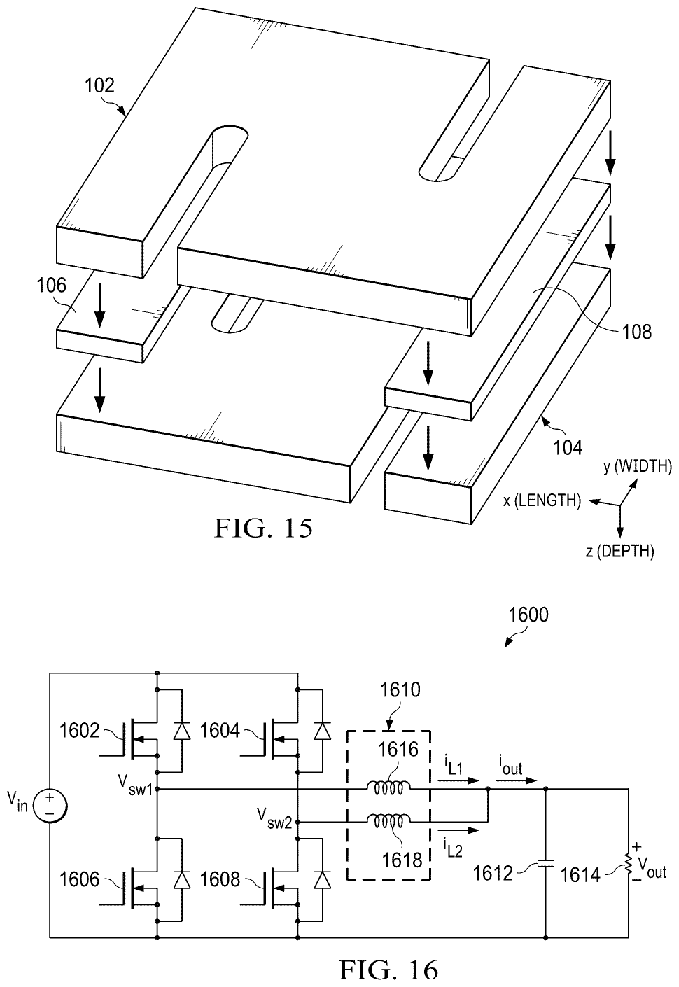

FIG. 15 illustrates a class of embodiments in which all four of the upper volume 102, the lower volume 104, the top volume 106, and the bottom volume 108 comprise discrete unitary elements that are assembled together, as shown, to form a complete core.

Other embodiments and modes of manufacture will be apparent to persons having skill in the art and having reference to the examples given herein.

### Example Host Systems

Coupled inductor components according to embodiments may be deployed in any of a wide variety of host systems in which coupled inductors provide utility.

One such host system, by way of example, is a two-phase switching power supply circuit such as the one illustrated at FIG. 16. Referring now to FIG. 16, switching power supply circuit 1600 is known as a two-phase buck converter. Such a converter includes two power supply inductors, one inductor for each of the two phases. Each of the inductor windings of a coupled inductor component according to embodiments may correspond to a respective one of the power supply inductors in such a circuit. For example, the illustrated converter 1600 has a supply voltage source, Vᵢₙ, coupled to an array of switching devices and, in some embodiments, diodes. (Note that the diodes shown in the drawing correspond to the body diodes of MOSFET switching devices. As persons having skill in the art will appreciate, however, in other buck converter embodiments, the bottom switching devices can be replaced with diodes.) The switching devices have control inputs, denoted in the drawing by transistor gates 1602, 1604, 1606, 1608, that are configured to alternately drive switch nodes V_{sw1} and V_{sw2}, each of which corresponds to one of the two phases of the two-phase converter circuit. Circuitry for driving the transistor gates may take any of a variety of known forms, so is not shown here in order not to overly complicate the illustration. Each switch node is coupled to one or more output capacitor(s) 1612 and to a load 1614 through one of two output inductors 1616, 1618. Each of the output inductors, in turn, corresponds to a respective one of the inductor windings of a coupled inductor device 1610.

Coupled inductor device 1610 may comprise any variant of the coupled inductor embodiments described herein. For example, coupled inductor device 1610 may correspond to either of coupled inductor devices 300 or 900 described above, and each of the inductor coils 1616, 1618 may correspond to a respective one of the two coupled inductor windings 302, 304 of the device.

### Dimensions, Parameter Variations, and Operating Characteristics

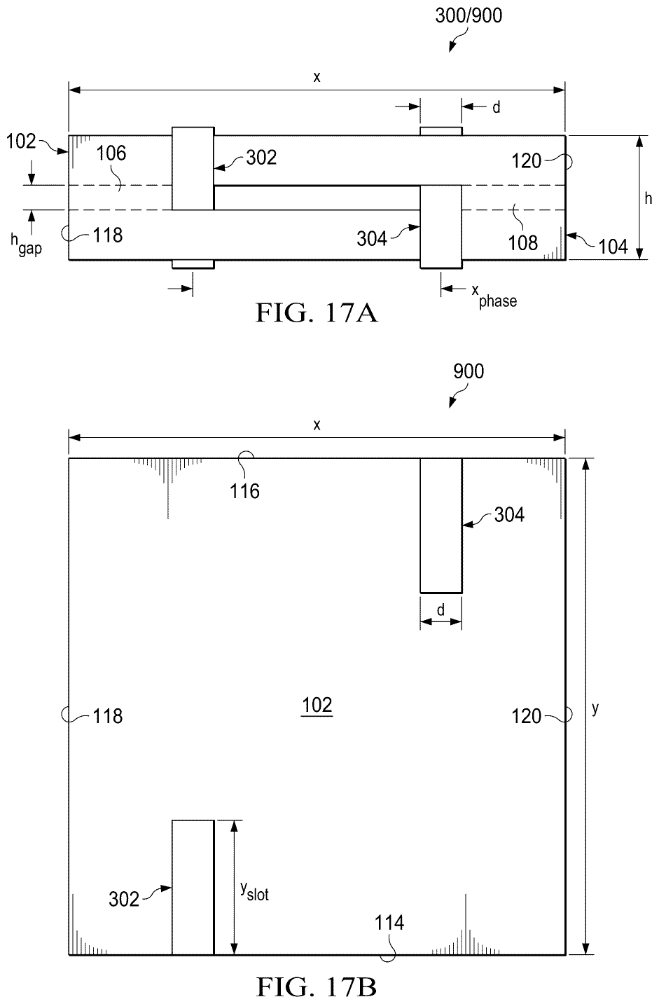

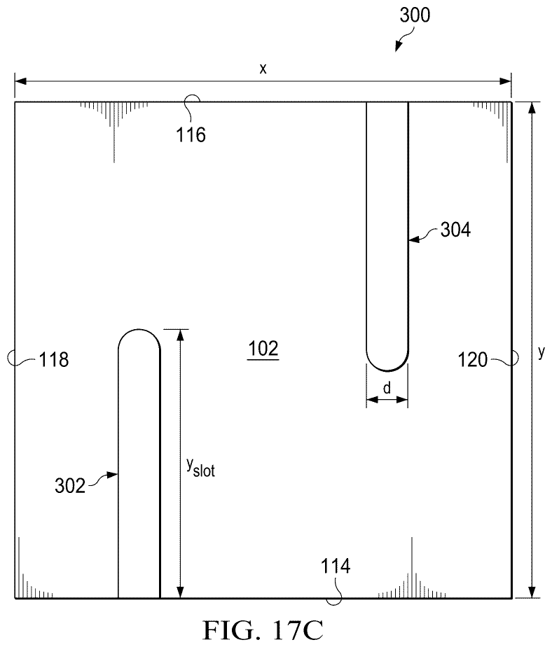

Referring now to FIGS. 17A, 17B, and 17C, the footprint of a coupled inductor device according to embodiments is defined by its length in the x dimension and by its width in the y dimension. The overall volume of such a device is defined by those two parameters and by its height, h, in the z dimension. Coupled inductor components according to embodiments may be designed with any combination of length, width, and height dimensions. An advantage, however, of the structures according to embodiments is that they may be designed so that the h dimension of the device is small. For example, units may be designed such that the h dimension is smaller than either of the x dimension or the y dimension of the unit. Thus, units according to embodiments may exhibit a low depth profile, which is useful in vertical power deliver applications.

Although the example embodiments described above each have a square footprint, in other embodiments the x and y dimensions need not be equal.

The width of the elongate gaps in the x dimension may be defined by the parameter d, and length of the elongate gaps in the y dimension may be defined by the parameter yₛₗₒₜ, as shown. The height of the main gap may be defined by the parameter h_{gap}, which sets the distance in the z dimension between the central portions of the upper and the lower core volumes as well as the height of the portions of the electrical conductors that traverse through the main gap. Together, the h_{gap} parameter and the distance between the centers of the two windings in the x dimension, xₚₕₐₛₑ, impact the strength of the magnetic coupling between the two inductors of the coupled inductor device. The yₛₗₒₜ parameter influences how the magnetic flux is patterned through the core. All of these parameters may be varied in embodiments to produce the characteristics desired for a given application, as will be apparent from the following discussion of simulation results in example embodiments.

Several simulations using ANSYS MAXWELL 3D modeling software will now be described by way of example and not by way of limitation. The simulations were performed to illustrate the characteristics of various embodiments when deployed in the two-phase buck converter circuit of FIG. 16. The B—H curve that was used to simulate the coupled inductor corresponds to that of the FLAKE-COMPOSITE material manufactured by Kemet Corporation.

In general, the steady-state inductance Lₚₛₛ for an individual one of the inductors in a two-phase coupled inductor device according to embodiments can be calculated from the inductor's self-inductance L_{S} and the mutual inductance L_{M} of the device as follows:

$${L}_{pss} = {L}_{S} \times \frac{1 - {k}^{2}}{1 + k ( \frac{D}{1 - D} )} \qquad ( 1 )$$

where the coupling coefficient k=L_{M}/L_{S} and the duty cycle D=Vₒᵤₜ/Vᵢₙ.

FIG. 18 shows plots of inductances and resistances in embodiments as the yₛₗₒₜ dimension is varied. The plots assume a core structure having x=6 mm, y=6 mm, h=1.5 mm, h_{gap}=0.3 mm, xₚₕₐₛₑ=3 mm, and r_{cu}=0.5 mm, where r_{cu} denotes the radius of copper conductors disposed in the through holes and thus d=1.0 mm. The plots further assume a DC bias current I_{DC}=5 A. The steady-state inductance displayed is plotted for the case where Vᵢₙ=6V and Vₒᵤₜ=0.8 V. As yₛₗₒₜ increases, the self inductance drops significantly. The steady-state inductance, however, only drops from 70 nH when yₛₗₒₜ=0.25 mm to 43 nH when yₛₗₒₜ=y/2+d_{cu}/2. Increasing yₛₗₒₜ to the point where the structure becomes a single-via structure as in embodiment 300 greatly reduces the DC resistance, from 0.9 mΩ to 0.06 mΩ.

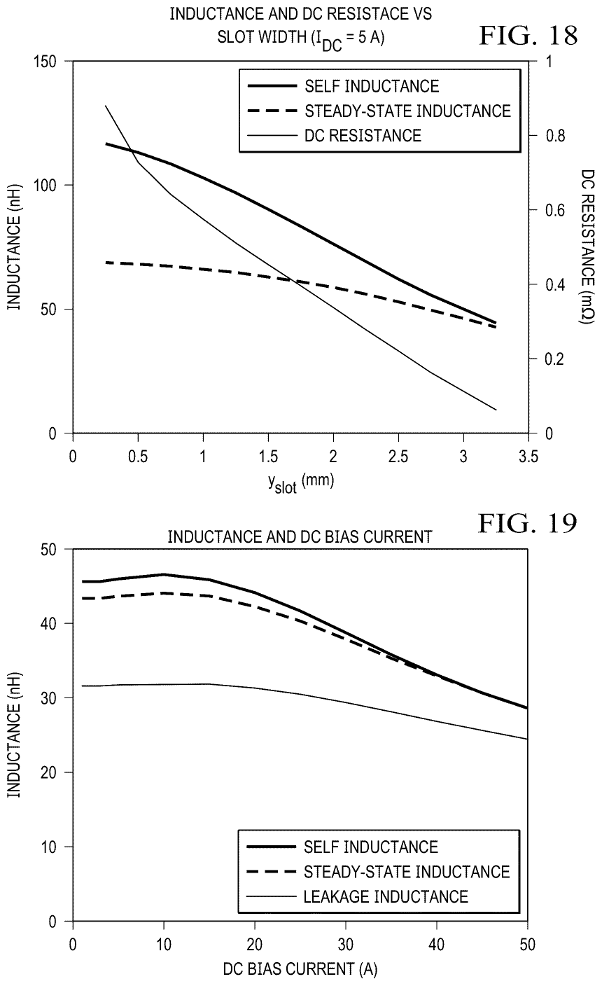

The plots shown in FIG. 19 assume a yₛₗₒₜ dimension that is fixed at yₛₗₒₜ=y/2+d_{cu}/2 while the rest of the geometric parameters of the device remain the same as those used in the simulation of FIG. 18. These plots show the inductance characteristics of the device as DC bias current increases. Self-inductance, steady-state inductance, and leakage inductance are all as shown. The steady-state inductance is the effective inductance during steady-state operation when the phases are interleaved with a phase shift of 180° between them. If the phases are in phase with each other, the leakage inductance is the effective inductance seen.

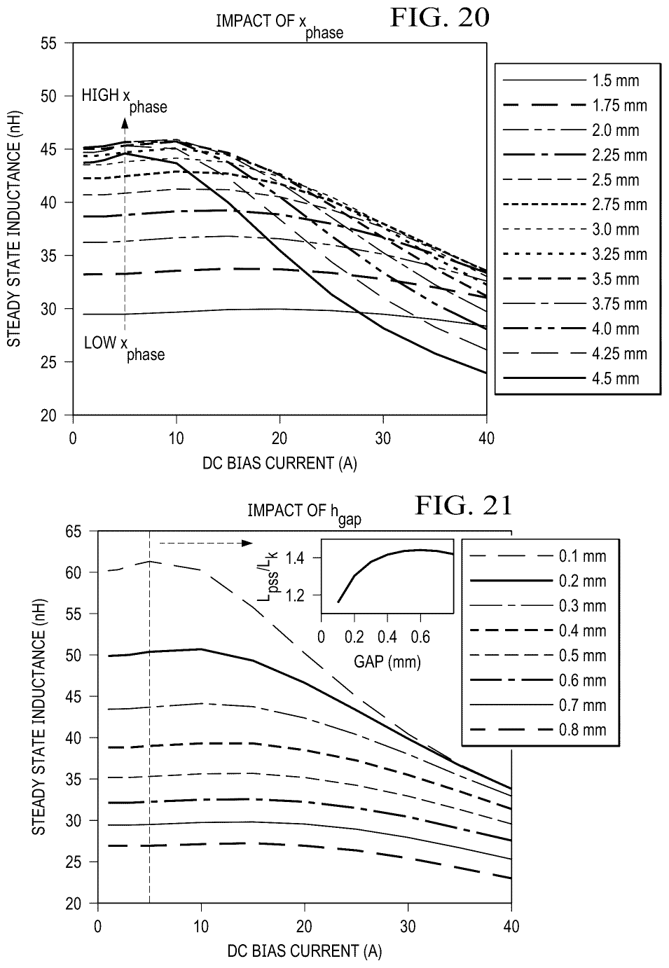

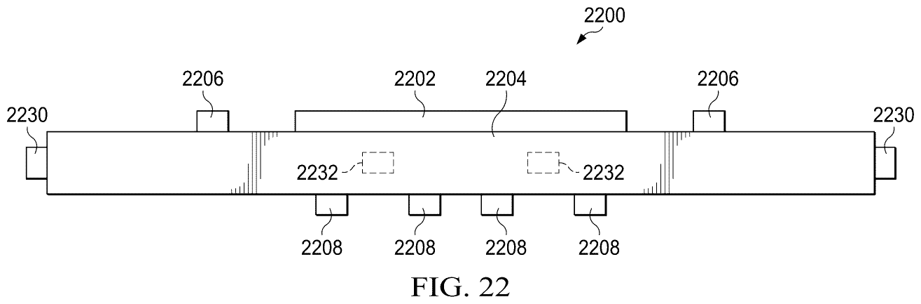

The plots of FIGS. 20 and 21 illustrate steady state inductance in embodiments 300 as a function of DC bias current and as certain device parameters are varied. In the plots of FIG. 20, the xₚₕₐₛₑ parameter is varied. In the plots of FIG. 21, the h_{gap} parameter is varied. The plots in both figures assume a device having dimensions x=6 mm, y=6 mm, h=1.5 mm, h_{gap}=0.3 mm, and d_{cu}=0.5 mm.

As FIG. 20 illustrates, for low values of xₚₕₐₛₑ, the two phases in the coupled inductor are strongly coupled. The high coupling results in a lower value of the steady-state inductance, but prevents the core from entering saturation at higher load currents because of the higher DC flux cancellation. As xₚₕₐₛₑ is increased to 3 mm, which is equal to x/2 in the device being simulated, the steady-state inductance reaches 43 nH at low DC bias current, which is close to the maximum achieved steady-state inductance of 45 nH when xₚₕₐₛₑ=4.5 mm. For xₚₕₐₛₑ=3 mm, however, the inductance drops to only 33 nH at I_{DC}=40 A, compared to 24 nH for xₚₕₐₛₑ=4.5 mm. Setting xₚₕₐₛₑ=x/2 achieves high steady-state inductance in light load and has enough coupling to keep the inductance high during heavy load, as this coupling helps to increase the DC flux cancellation and to prevent saturation.

As h_{gap} increases, the magnetic coupling increases. This results in a decrease in the steady-state inductance at light load, but a flatter steady-state inductance curve as the DC bias current increases. For I_{DC}=5 A (indicated with the dashed line in FIG. 21), the smaller inset plot shows how Lₚₛₛ/Lk varies as the gap is changed, where Lk represents the leakage inductance. (Note that the leakage inductance is equal to the sum of the self inductance and the mutual inductance. That is, Lk=Ls+L_{M}, wherein La is negative due to the inverse coupling in the device.) The latter ratio represents the impact of coupling on the trade-off between steady-state inductance and leakage inductance. The ratio exceeds 1.4 at a gap around 0.35 mm, and any subsequent increase in the gap does not increase the ratio by much, but results in a decrease in the overall steady-state inductance.

### Example Placements On or Inside an IC Substrate

FIG. 22 is a side view of an integrated circuit chip package 2200 comprising one or more integrated circuit chips or dies 2202 mounted on a substrate 2204 according to any of various known methods.

Coupled inductor components according to any of the embodiments described herein may be disposed on an exterior surface of substrate 2204, or inside the substrate, in several possible locations. If desired, each such component may also be coupled to host circuitry such as a two-phase buck converter circuit as described above, and the host circuitry may be located on or inside the substrate, inside the integrated circuit die, or on a host printed circuit board to which the substrate 2204 is mounted.

By way of example, one or more coupled inductor components 300 and/or 900 may be mounted on a top surface of the substrate as shown at 2206, on a bottom surface of the substrate as shown at 2208, including underneath chip die 2202, or on one or more side surfaces of the substrate as shown at 2230. In addition, one or more coupled inductor components 300 and/or 900 may be disposed inside the substrate as shown at 2232, such as by inserting the components inside voids formed in the substrate or by forming the components directly in the substrate. Once so disposed, the inductor components can be coupled to host circuitry by means of conductive traces formed in the substrate and/or by conductive vias and the like in accordance with know techniques.

Multiple specific embodiments have been described above and in the appended claims. Such embodiments have been provided by way of example and illustration. Persons having skill in the art and having reference to this disclosure will perceive various utilitarian combinations, modifications and generalizations of the features and characteristics of the embodiments so described. For example, steps in methods described herein may generally be performed in any order, and some steps may be omitted, while other steps may be added, except where the context clearly indicates otherwise. Similarly, components in structures described herein may be arranged in different positions or locations, and some components may be omitted, while other components may be added, except where the context clearly indicates otherwise. The scope of the disclosure is intended to include all such combinations, modifications, and generalizations as well as their equivalents.

1. A system, comprising:
a magnetic inductor core that forms a three-dimensional figure eight pattern, wherein:
an upper member of the core forms an upper half of the figure eight pattern;
a lower member of the core forms a lower half of the figure eight pattern;
central portions of the upper member and of the lower member are separated from one another in a depth dimension by a main gap that passes transversely through the core from left to right sides of the figure eight pattern; and
the upper member and the lower member are joined with one another at top and bottom sides of the figure eight pattern by members of the core that extend in the depth dimension between the upper member and the lower member at top and bottom sides thereof.

2. The system of claim 1, further comprising:
first and second conductors disposed at least partially in the core and configured to conduct electrical current in a manner such that magnetic flux associated with the respective conductors follows the figure eight pattern in opposite directions inside the core.

3. The system of claim 2, wherein:
wherein the first and second conductors comprise first and the second coupled inductor windings, respectively, of a coupled inductor component.

4. The system of claim 3, further comprising:
a two-phase switching power supply circuit comprising first and second power supply inductors; and
wherein the first and the second coupled inductors correspond, respectively, to the first and the second power supply inductors of the power supply circuit.

5. The system of claim 3, wherein:
the coupled inductor component is disposed on an exterior surface of an integrated circuit chip substrate.

6. The system of claim 3, wherein:
the coupled inductor component is disposed inside an integrated circuit chip substrate.

7. The system of claim 1, wherein:
the upper member defines two upper elongate gaps, a first one of which extends partially into the upper member from the left side, and a second one of which extends partially into the upper member from the right side; and
the lower member defines two lower elongate gaps, a first one of which extends partially into the lower member from the right side, and a second one of which extends partially into the lower member from the left side.

8. The system of claim 7, further comprising:
first and second longitudinal conductors, each axially oriented along the depth dimension;
wherein the first longitudinal conductor passes through at least portions of the first elongate gap of the upper member, the main gap, and the first elongate gap of the lower member; and
wherein the second longitudinal conductor passes through at least portions of the second elongate gap of the upper member, the main gap, and the second elongate gap of the lower member.

9. The system of claim 8, wherein:
the first longitudinal conductor further comprises transverse conducting elements substantially filling the first elongate gaps of the upper member and of the lower member; and
the second longitudinal conductor further comprises transverse conducting elements substantially filling the second elongate gaps of the upper member and of the lower member.

10. The system of claim 8, wherein:
the first and second longitudinal conductors each have a diameter d;
the core has a length y in the transverse dimension; and
each of the elongate gaps has a length substantially equal to y/2+d/2.

11-13. (canceled)

14. The system of claim 1, wherein:
the core comprises two or more pieces of magnetic material assembled together.

15. The system of claim 1, wherein:
the core comprises a unitary piece of magnetic material.

16. An inductor, comprising:
a core of magnetic material defining a core length that extends in an x direction from a top side to a bottom side the core, a core width that extends in a y direction from a left side to a right side of the core, and a core depth that extends in a z direction from an upper side to a lower side of the core, and including upper, lower, top, and bottom volumes;
wherein the upper volume and the lower volume are disposed opposite one another in the z direction and extend laterally across the core length and laterally across the core width;
wherein each of the upper volume and the lower volume includes two elongate gaps that extend partially across the core width from opposite sides, creating a generally S shaped profile in each of the respective volumes in a manner such that the S shaped profiles of the top volume and of the bottom volume face in opposite directions;
wherein the top volume and the bottom volume are each disposed between the upper volume and the lower volume and are separated from one another in the x direction such that a main gap extends in the y direction across the core width between the top volume, the bottom volume, the upper volume, and the lower volume;
wherein the elongate gaps of the upper volume and the elongate gaps of the lower volume are disposed adjacent to the main gap such that the elongate gaps and the main gap form a continuous volume in which the magnetic material of the core is absent; and
two electrical conductors, each at least partially disposed in the main gap, in one of the elongate gaps of the upper volume, and in one of the elongate gaps of the lower volume, and each configured to conduct electrical current along a path that enters through the upper volume and exits through the lower volume or that enters through the lower volume and exits through the upper volume.

17. The inductor of claim 16, wherein:
the upper, lower, top, and bottom volumes comprise discrete elements.

18. The inductor of claim 16, wherein:
the upper volume and the lower volume comprise discrete elements; and
the top volume and the bottom volume are both integrally formed with the upper volume or with the lower volume.

19. The inductor of claim 16, wherein:
the upper volume and the lower volume comprise discrete elements; and
at least a portion of one of the top volume and the bottom volume is integrally formed with the upper volume, and at least a portion of the other one of the top volume and the bottom volume is integrally formed with the lower volume.

20. The inductor of claim 16, wherein:
the elongate gaps are sufficiently long that end portions of the elongate gaps in the upper volume overlap end portions of the elongate gaps in the lower volume, thereby defining two through holes in the core; and
each of the two electrical conductors comprises a longitudinal conducting element that is oriented in the z direction and is disposed at least partially inside one of the through holes.

21. The inductor of claim 20, wherein:
the longitudinal conducting element has a diameter d;
the core width has a length w; and
each of the elongate gaps has a length substantially equal to w/2+d/2.

22. The inductor of claim 20, further comprising:
conductive material substantially filling each of the elongate gaps.

23-24. (canceled)

25. The inductor of claim 16, wherein:
each of the two electrical conductors comprises copper.

26. The inductor of claim 16, wherein:
the magnetic material comprises manganese-zinc ferrite or nickel-zinc ferrite.

27. An inductor, comprising:
a core of magnetic material defining a rectangular volume having top and bottom faces orthogonal to an x direction, left and right faces orthogonal to a y direction, and upper and lower faces orthogonal to a z direction, and defining a main gap that passes completely through the volume in the y direction;
wherein the upper face defines an upper left elongate gap that extends partially into the upper face from the left, the lower face defines a lower right elongate gap that extends partially into the lower face from the right, and the upper left and the upper right elongate gaps are both at least partially disposed in a first y-z plane;
wherein the upper face defines an upper right elongate gap that extends partially into the upper face from the right, the lower face defines a lower left elongate gap that extends partially into the lower face from the left, and the upper right and the lower left elongate gaps are both at least partially disposed in a second y-z plane;
wherein the first y-z plane is separated from the second y-z plane in the x direction by a phase distance; and
wherein the first y-z plane and the second y-z plane both pass through the main gap such that all of the elongate gaps are continuous with the main gap.

28. The inductor of claim 27, further comprising:
a first conductor disposed in at least parts of the upper left and the lower right elongate gaps; and
a second conductor disposed in at least parts of the upper right and the lower left elongate gaps.

29. The inductor of claim 28, wherein:
the elongate gaps are sufficiently long to establish first and second through holes passing through the core in the z direction;
the first conductor includes a first longitudinal element oriented in the z direction and disposed in the first through hole; and
the second conductor includes a second longitudinal element oriented in the z direction and disposed in the second through hole.

30. The inductor of claim 29, wherein:
the first and the second longitudinal elements each have a diameter d;
the core has a width w in the y direction; and
each of the elongate gaps has a length substantially equal to w/2+d/2.

31. The inductor of claim 29, further comprising:
conductive elements substantially filling each of the elongate gaps;

32. (canceled)
